(19) United States
(12) Patent Application Publication
(10) Pub. No.: US 2004/0015965 A1
(43) Pub. Date: Jan. 22, 2004

(54) Installation-free middleware demonstration system

(76) Inventor: Malcom Sparks, Co. Dublin (IE)

Correspondence Address: LACASSE & ASSOCIATES, LLC, 1725 DUKE STREET, SUITE 650, ALEXANDRIA, VA, 22314, US

(21) Appl. No.: 10/162,177

(22) Filed: Jun. 3, 2002

Related U.S. Application Data
(60) Provisional application No. 60/295,354, filed on Jun. 2, 2001.

(51) Int. Cl. G06F 9/445

(52) U.S. Cl. 717/178

(57) ABSTRACT

A middleware demonstration system without requiring installation of the middleware and a server is disclosed. A preferred embodiment of the middleware demonstration system comprising a CD-ROM containing a middleware program; an application server program; and a demonstration program configured to automatically load and execute the middleware program and server program on a single computer and to temporarily store the demonstration application data and the demonstration configuration data on the computer in a working middleware system is disclosed.

### BACKGROUND OF THE INVENTION

Middleware systems are software systems that handle the communication between distributed software objects. Examples of middleware systems include CORBA, Java RMI and DCOM.

Because middleware systems provide services to distributed applications, middleware systems normally require complex installation procedures before they can be run. In addition to the middleware itself, distributed application components or modules such as one or more databases and associated network drivers such as JDBC or ODBC and/or an HTTP server must be installed to enable a running middleware system. Often additional resources such as a Java runtime environment (JRE) or development kit (JDK) must also be installed. This complex installation process is a serious barrier to product demonstration, because much time, effort and expertise is normally required to complete the installation.

In addition, a middleware installation is typically difficult to reverse, and changes to the computer system on which the middleware system is install often persist long after the demonstration is finished. These durable changes are also a serious disincentive to a potential customer who might otherwise wish to run a demonstration version of middleware product.

There is thus a need for a middleware product preview system that provides a running middleware system without requiring actual installation or any persisitant changes to a computer system on which the middleware system is demonstrated.

### SUMMARY OF THE INVENTION

One aspect of the present invention comprises a software demonstration system that further comprises a single tangible recording medium comprising recorded data, the data further comprising a middleware program comprising services such as locator and naming services; an application server program; demonstration application data;

demonstration configuration data; and a demonstration program configured to automatically load and execute the middleware program and server program on a single computer and to temporarily store the demonstration application data and the demonstration configuration data on the computer in a working middleware system.

### BRIEF DESCRIPTION OF THE DRAWINGS

FIG. 1 shows a flow chart schematically depicting options and steps of the demonstration program of the preferred embodiment.

FIG. 2 shows the browser interface for the application server of the preferred embodiment.

FIG. 3 shows the demonstration program interface window when the option “Preview iPAS” is selected.

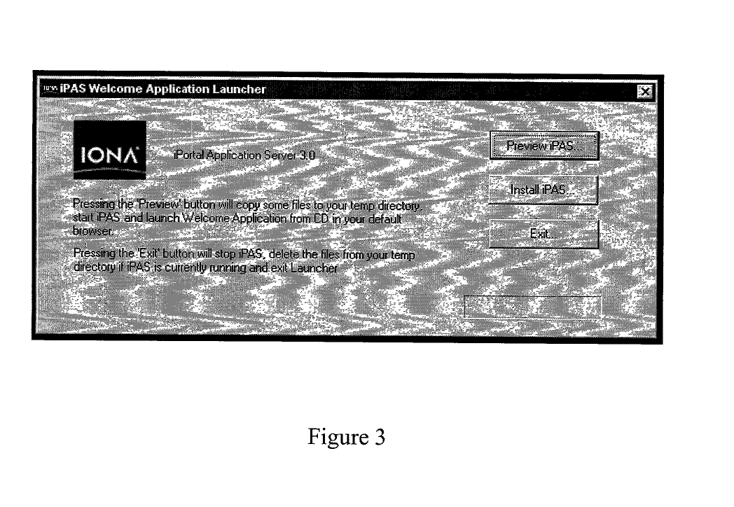

FIG. 4 shows the demonstration program interface window when the option “Install iPAS” is selected.

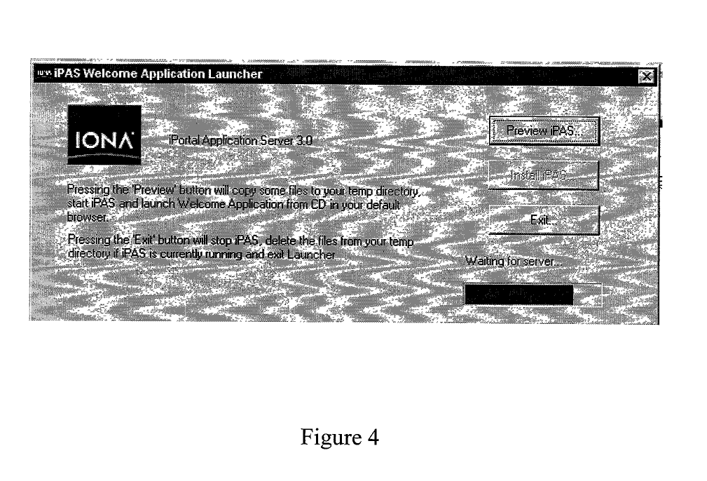

FIG. 5 shows the demonstration program interface window when the option “Exit” is selected.

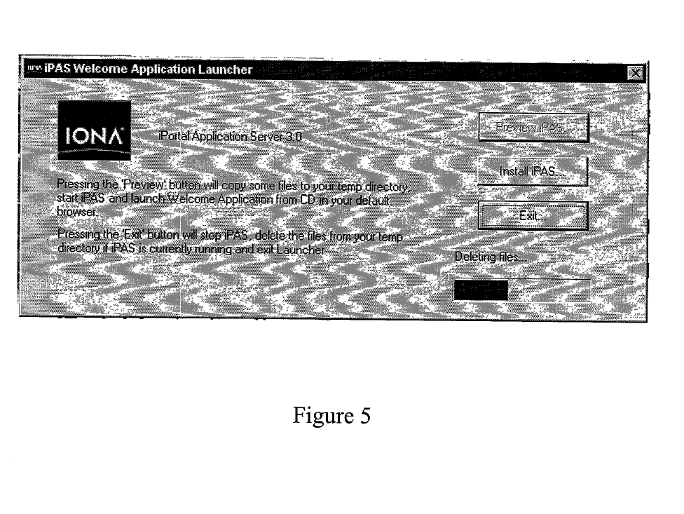

### DESCRIPTION OF THE PREFERRED EMBODIMENTS

The present invention comprises a middle demonstration system providing a running middleware system without installation. All resources necessary to fully preview the product are included on a distribution medium, such as a CD or downloadable archive file. On mounting the distribution medium, using autostart, or on user command, the system copies necessary files (files which must be writeable and therefore must be transferred from CD) to a temporary directory on the user's disk. The system then starts to run the middleware system.

All durable changes to the user's system are reversible by the demonstration system, which will delete all files copied to the temporary directory and any registry entries made. In a preferred embodiment, no registry entries are necessary. After copying any necessary files, the system starts any services necessary to demonstrate the middleware by executing files on the distribution medium. After starting the necessary services, the demonstration system starts the middleware system by executing files on the distribution medium. The middleware and necessary services executables are configured to use files in the temporary directory to provide configuration information allowing middleware functionality to be demonstrated and altered by the user without permanently installing any files on the user's computer.

One embodiment of the demonstration system comprises a single tangible recording medium comprising recorded data, the data further comprising:

a middleware program;

an application server program;

demonstration J2EE application data;

demonstration configuration data; and

a demonstration program configured to automatically load and execute the middleware program and server program on a single computer and to temporarily store the demonstration application data and the demonstration configuration data on the computer in a working middleware system. Preferably the middleware program comprises an Enterprise JavaBean server, preferably supporting the Java Naming and Directory Interface (JNDI).

The demonstration system is preferably further configured to allow users to interact with and change the operation of the middleware program dynamically.

The demonstration system is preferably further configured to reverse all durable

changes to the computer on completion of the demonstration.

With this system, users can preview, interact with and dynamically alter the operation of a middleware program from the distribution medium.

A preferred embodiment of the present invention comprises a CD-ROM referred to as the iPortal Application Server 3.0 CD-ROM. Using this CD-ROM, users can preview a fully operational instance of CORBA middleware with the application server program—iPortal Application Server 3.0, and its associated services with a pre-deployed J2EE application before installing anything, and without the need of any other pre-installed software (e.g. JDK).

The iPortal Application Server 3.0 CD-ROM further comprises an Embedded Locator and Naming Services, an iPortal Administrator, JDBC Drivers and a “Welcome App J2EE Application” program serving as the demonstration program.

Once the CD-ROM has been mounted into a Windows NT/2000 machine with autoplay enabled, the Welcome Application Launcher application will pop up presenting the user with three options. These options are:

1. Preview iPAS—which will start the server with the Welcome application.

2. Install iPAS

3. Exit.

Wherein, the “Preview iPAS” option allows the running of a full instance of the iPortal Application Server from a CD without installation. Specifically, the steps involved in this option are:

a. Copy files necessary files to the user's temp directory. These directories/files are the archives, repository, logs, events, domains and JDBC.

b. Start the server.

c. Ping the server until a valid response is received, this is essentially a wait for server. The timeout is preferably about 3 minutes.

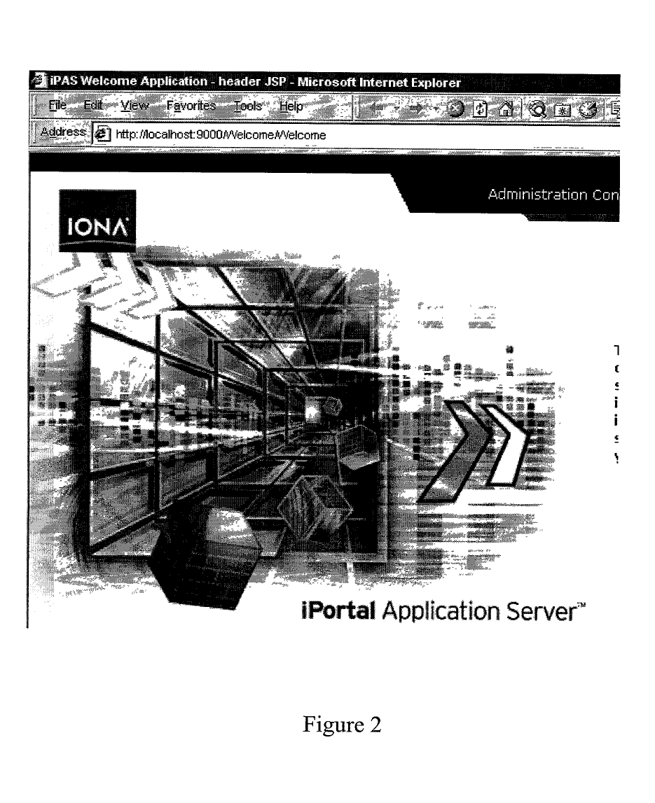

d. Once the server is operational, the default browser as shown in FIG. 2 is started and pointed at the Welcome Application.

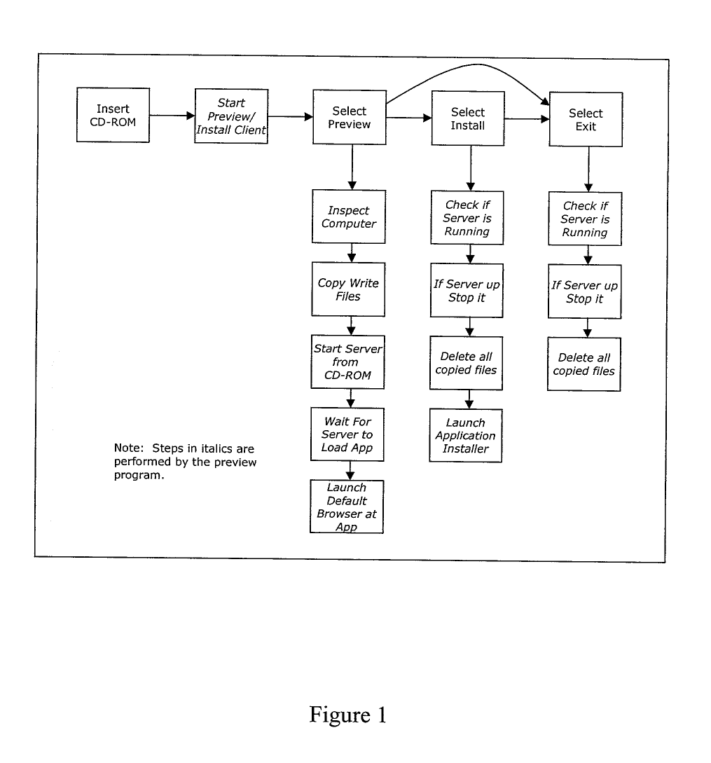

The user's temporary directory is preferably used for files that have to be writable or read-write in order for the server to run. These files are deleted from the users machine on exit or in the case where install is selected. Also, the server is shut down depending on the user's choice. The three preferred options and their preferred steps are schematically illustrated in FIG. 1.

The present invention can be used to provide full working previews of any middleware product distribution. Previews can be specifically tailored to demonstrate dynamic operation and configuration as well as the normal operation of the middleware without installing the product and without leaving any footprint on the demonstrating computer.

What is claimed is:

1. A software demonstration system comprising a single tangible recording medium comprising recorded data, the data further comprising:
a middleware program;
an application server program;
demonstration application data;
demonstration configuration data; and
a demonstration program configured to automatically load and execute the middleware program and server program on a single computer and to temporarily store the demonstration application data and the demonstration configuration data on the computer in a working middleware system.

2. The software demonstration system of claim 1, wherein the demonstration program is futher configured to allow users to interact with and change the operation of the middleware program dynamically.

3. The software demonstration system of claim 1, wherein the demonstration program is further configured to reverse all durable changes to the computer on completion of the demonstration.

4. The software demonstration system of claim 1, wherein the locator and naming services comprise Java Naming and Directory Interface.

5. The software demonstration system of claim 1, wherein demonstration application data comprises data for J2EE applications.
